(19) United States
(12) Patent Application Publication
(10) Pub. No.: US 2009/0240622 A1
(43) Pub. Date: Sep. 24, 2009

(54) Method and System for Payment Processing

(76) Inventor: Andre Luis Zandonadi, Uberiandia Minas Gerais (BR)

Correspondence Address: GIBSON & DERNIER L.L.P., 900 ROUTE 9 NORTH, SUITE 504, WOODBRIDGE, NJ, 07095, US

(21) Appl. No.: 12/050,450

(22) Filed: Mar. 18, 2008

(51) Int. Cl. G06Q 20/00

(52) U.S. Cl. 705/40

(57) ABSTRACT

A system and method are provided which include providing a payment processor including a first processing module identifying the payer and an actual payment due based upon received information and a second processing module determining the account from which the actual payment due is to be paid based on the stored information. Communication is had with the payment processor via a mobile device to provide information about an actual payment due by a payer, and the payment processor effectuates payment of the actual payment due in accordance with the stored information.

### TECHNICAL FIELD

The present invention relates to a method and system for processing payments in conducting commercial transactions of any type, and is preferably, but not necessarily, utilized for facilitating payment between mobile devices such as cell phones and the like.

### BACKGROUND OF THE INVENTION

The adoption of mobile phone technology for the purpose of payment is described in European patent application EP 01102566. This patent refers to the input of data into a cash register and the transmission of the data to the mobile phone via a short-distance network. Once the customer confirms the payment information transmitted by the short-distance network using a mobile device, a payment instruction is generated and transmitted by the means of the mobile device. In this system, the amount that will be paid is confirmed by the customer before the payment instruction is generated in order to validate the customer identity.

In U.S. Pat. No. 7,069,001 to Rupp et al. the customer identity is authenticated by the mobile network authentication server, such as a Home Location Registry (HLR) in case of a Global System for Mobile Communications (GSM) network, using the subscriber identification module key and the authentication algorithm adopted in the mobile network. In the same application, the payment information is transmitted via a short distance network from the cash register to the mobile phone or entered in the cash register by the customer.

Another approach is disclosed in U.S. Pat. No. 7,124,937 to Myers et al., in which a transaction is conducted using two portable devices. A secure connection is established between the two portable devices to initiate a transaction. The transaction is approved by both portable devices and sent to a payment hub service for clearing purpose. The security is provided by a residing application installed in both portable devices.

In co-pending U.S. patent application Ser. No. 11/736,893, the entire disclosure of which is incorporated herein by reference, there is disclosed a method and system for conducting wireless commercial transactions using at least one wireless mobile device, a processing center, and a third party device, which may be a second wireless mobile device. This permits wireless commercial transactions between parties which may be remote from each other.

There is a need in the art for an improved system for conducting commercial transactions between devices, one or more of which may be wireless, and which may be remotely located from one another.

### SUMMARY OF THE INVENTION

A system and method are provided which include providing a payment processor including a first processing module identifying the payer and an actual payment due based upon received information and a second processing module determining the account from which the actual payment due is to be paid based on the stored information and/or information input by a user. Communication is had with the payment processor via a mobile device to provide information about an actual payment due by a payer, and the payment processor effectuates payment of the actual payment due in accordance with the stored information.

Although primarily applicable to payment of standard bills, the technology is applicable to other financial transactions as well, such as purchases, electronic funds transfers, and others. Additionally, one or more of the terminals involved in the transaction may be wired terminals, such as PCs, ATM machines, etc.

In accordance with an aspect of the invention, the payment processor includes a payment analysis module responsive to stored and received information to determine which account should best be used to make an actual payment due, the payment analysis module determining a recommended account for payment of the actual payment due and communicating the recommendation to the mobile device for optional approval or alteration by the user/payer.

In accordance with another aspect of the invention, a reminder is stored about when an actual payment is due and a reminder message is sent to the mobile device when the payment is due, along with a recommendation concerning source of payment.

### BRIEF DESCRIPTION OF THE DRAWINGS

The foregoing brief description and further objects, features, and advantages of the present invention would be understood more completely from the following detailed description of presently preferred, but nonetheless illustrative, embodiments in accordance with the present invention, with reference being had to the accompanying drawings, in which:

FIG. 1 is a block diagram of a communication system able to conduct commercial transactions in accordance with the present invention;

FIG. 2 is a block diagram showing the mobile device and the Subscriber Identity Module (SIM) card of FIG. 1 in greater detail;

FIG. 3 is a block diagram illustrating the insertion of an encrypted application message into a short message in accordance with an example of the invention;

FIG. 4 is a block diagram of the processing center of FIG. 1;

FIG. 5 is a flow diagram summarizing a cashless payment method in accordance with an embodiment of the present invention;

FIG. 6 is a flow chart illustrating the overall process performed by the payment processor; and

FIG. 7 is a flow chart illustrating the process performed by the payment processor to generate payment reminders.

### DETAILED DESCRIPTION OF THE EMBODIMENTS

A first embodiment of the present invention includes transactions between two parties, a payer and a payee, who may use respective portable electronic devices to communicate to a processing center in order to conduct cashless payment transactions.

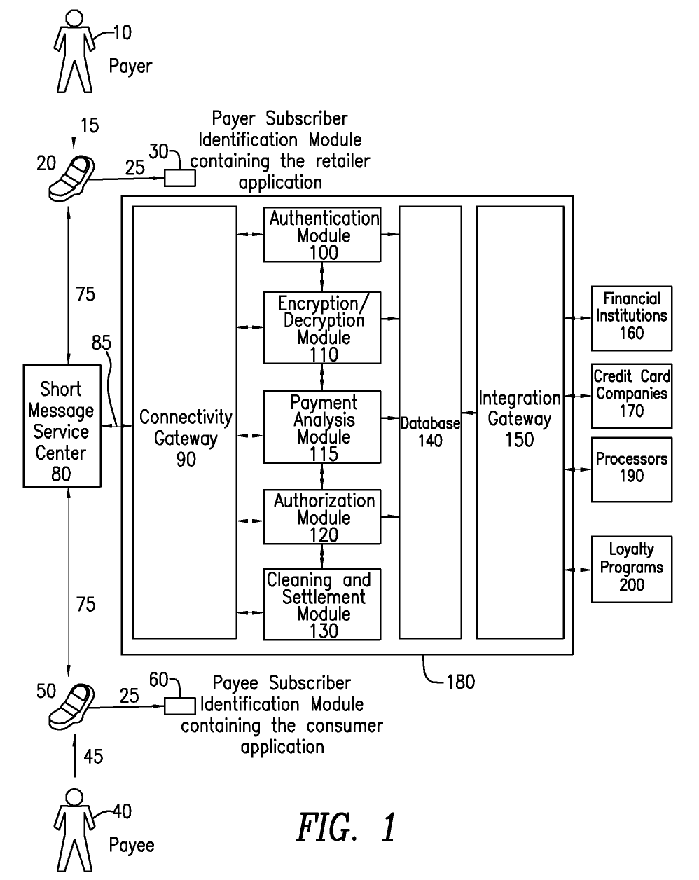

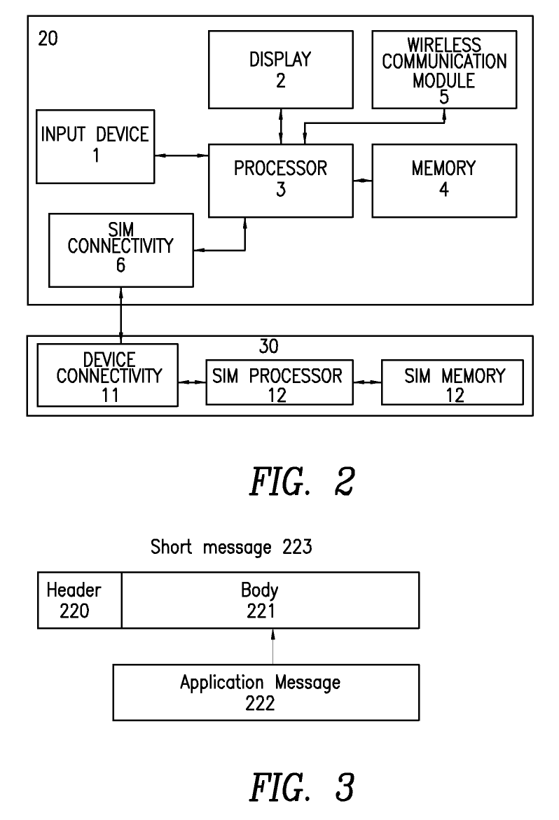

FIGS. 1 and 2 show the functional components of a system embodying the invention, which may include a payer 10, mobile device 20, payer SIM 30, short message service center (SMSC) 80, processing center 180, one or more financial institutions 160, credit card companies 170, processors 180 and loyalty programs 190. Additionally, the payee 40 is shown utilizing one of many possible payee devices 45, which, in a preferred embodiment, include a mobile device as shown. The financial transaction system of FIG. 1 may be employed to enable commercial transactions by a consumer using a mobile device 20 via processing center 180, which is an intermediary therefore.

It will be appreciated that, although a single payer is shown in FIG. 1, the system will typically involve a large number of payers, as well as payees, which can similarly communicate with the processing center 180. Although SMSC is shown as exemplary, other protocols such as GPRS or EDGE, or any others can be used.

Herein, a commercial transaction may include a transaction between a mobile device and a conventional payee computer or between two mobile devices. The transaction may involve one or more transfers of funds and/or the provision of a service or product, which may be in exchange for the transfer of funds. The payment being processed involves a transfer of funds from the payer to a recipient. A commercial transaction could further include controlling a final transfer of value to mobile device 20 or other device based on the provision of a service or product to payer 10. A mobile device will be understood to include any type of communication device, including but not limited to a cell phone, a notebook computer, or a personal digital assistant (PDA).

Non-mobile devices that may be involved in a transaction include, a cash register (such as at a retail establishment) with suitable communication capability, an Internet commerce site, and an automatic teller machine (ATM).

In the embodiment of FIG. 1, the payer 10 interfaces with the mobile device 20 by its keys and display, in this case represented by link 15. The mobile device 20 may be a portable device employing wireless communication such as: a Global System for Mobile Communications (GSM) mobile phone, a Universal Mobile Telecommunications System (UMTS) mobile phone, a Code Division Multiple Access (CDMA) mobile phone, a Wideband Code Division Multiple Access (W-CDMA) mobile phone or equivalent equipment. The present invention is thus not limited to using mobile devices employing the above-identified communication standards.

Moreover, the present invention is not limited to the use of wireless communications. Devices employing wired communication means may also be employed for one or more devices participating in a commercial transaction that uses the processing center 180 as an intermediary. The mobile device 20 may be coupled to a Subscriber Identity Module (SIM) card 30 or an equivalent thereto. The mobile device 20 may be coupled to the payer Subscriber Identity Module (SIM) card 30, which may be a smart card equipped with microprocessor and memory, that securely stores a secret key that the standard Global System for Mobile Communications (GSM) network uses to identify a mobile phone subscriber in its network, as well as stores other information, such as telephone numbers, mobile phone configuration preferences, text messages and other information. SIM card 30 may include software that is customized for performing the functions of the present invention. However, alternatively, if available, existing software modules may be combined to perform a selection of the needed functions. While the foregoing example uses the SIM card for the software application, use of conventional EEPROM or other more permanent storage is also contemplated.

Mobile device 20 has software installed in its Subscriber Identity Module (SIM) card 30 to perform payer functions involved in a transaction. These would include confirming purchase information and validating the transaction using a personal password. As an example, payees may be retail merchants, grocery stores, restaurants, etc. while payers may be consumers, such as, individual persons. A commercial transaction may be initiated by either a payee or a payer. Moreover, either of a payer or payee may be any of individual persons, retail outlets, machines such as ATMs or store cash registers, Internet commerce sites, or other entity capable of participating in a funds transfer or other form of commercial transaction.

In the embodiment of FIG. 1, the payee mobile device 50 may contain a retailer application. The retailer application displays menu or other interface to allow for the input of data relevant to a financial transaction to be undertaken.

FIG. 2 is a functional block diagram of a preferred mobile device 20 that includes a processor 3 (e.g., a microprocessor) coupled to a memory unit 4 comprising a computer readable medium, one or more input devices 1, a display 2, a wireless communication module 5, and connectivity 6 to SIM card 30. FIG. 2 also shows Subscriber Identity Module (SIM) (subscriber identity module) card 30. The memory unit 4 may include one or more memory devices working in association with each other or separately. The wireless communication module 5 exchanges wireless signals with the wireless network via a communication protocol, such as standard Global System for Mobile Communications (GSM), Wideband Code Division Multiple Access (W-CDMA) or an equivalent communication protocol. However, any suitable protocol may be used.

In FIG. 2, the one or more the one input devices 1 may include a keyboard, a touch sensitive pad, and a voice-recognition system or equivalent device. The display 2 may include a Liquid Crystal Display (LCD), Light Emitting Diodes (LED) and/or any other suitable display. The display 2 allows the Payer 10 and Payee 40 and 180 to interact with one or more software applications operating within the system of FIG. 1 to conduct one or more commercial transactions.

In the embodiment of FIG. 2, the Subscriber Identity Module (SIM) card 30 securely stores information, according to Global System for Mobile Communications (GSM) technical specifications 3GPP TS 51.011, 3GPP TS 51.014, 3GPP TS 23.040, 3GPP TS 23.041 and 3GPP TS 23.048 or equivalent technical specification for the wireless technology adopted. However, the invention is not limited to foregoing specifications, and data may be stored in accordance with any suitable data storage protocol. The Subscriber Identity Module (SIM) card 30 may include connectivity 11 to device 20, Subscriber Identity Module (SIM) card processor 12 and the Subscriber Identity Module (SIM) card memory 13. The Subscriber Identity Module (SIM) card processor 12 and Subscriber Identity Module (SIM) card memory 13 may execute applications, according to Global System for Mobile Communications (GSM) technical specification 3GPP TS 43.019 or equivalent technical specification of the wireless technology adopted. However, the invention is not limited to executing applications according to the listed specifications. Indeed, processor 12 may execute software applications in accordance with any suitable specification. The Subscriber Identity Module (SIM) connectivity means 11 may be a smart card communication interface according to the ISO 7816 standard or equivalent standard according to the mobile device communication interface. It is noted that the present invention is not limited to the above-listed standards for communication between device 20 and SIM card 30 and that any suitable communication interface may be employed.

The Subscriber Identity Module (SIM) card memory unit 13 may use an electrical, magnetic or optical mechanism as a computer readable medium for data storage. Several technologies can be adopted as the computer readable medium, such as optical disk, memory chips (e.g., Random Access Memory (RAM) chip, Read Only Memory (ROM) chip, Electrically Erasable Programmable Read Only Memory (EEPROM) chip) or equivalent technology.

The Subscriber Identity Module (SIM) card 30 may provide a set of Application Programming Interfaces (API) for software application codification which is called Subscriber Identity Module (SIM) Application Programming Interfaces (API). The Global System for Mobile Communications (GSM) technical specification 3GPP TS 43.019 describes the functional capabilities and the information flow for the SIM API implemented on the Java Card 2.1 API. According to this specification, the Subscriber Identity Module (SIM) card 30 may instruct the portable electronic device 20 to execute a set of predefined functions. For example, the SIM card memory 13 may contain code for transmitting a purchase request from a portable electronic device to a card processor through a GSM network and code for receiving approval of the sale request, wherein the approval is sent from the card processor to the portable electronic device through the standard GSM network.

A short message is a text message type that may be used to conduct data communication between one or more mobile devices and/or between a mobile device and a software application running on a communication node in a mobile network. The short message service is available on most digital mobile phones and other mobile devices, such as a Pocket Personal Computer (Pocket PC). The text size may vary according to the network configuration but the average size is 160 bytes. However, messages shorter than or longer than 160 bytes may be transmitted using the system and method of the present invention.

Referring to FIGS. 1 and 3, the short message may include a header 220 and a body 221. The short message header 220 contains information about its source and destination while the short message body 221 is composed of the application message which contains specific information about its operation and data. The application message 222 contains operation information and data for each electronic transaction. The application message is inserted in a short message, which is delivered to the processing center 180. In this context, the Short Message Service Center (SMSC) 80 is the entity responsible for carrying the short message 223 between the mobile devices 20, 50 and the processing center 180. In the embodiment of FIG. 1, short messages 223 generated by the retailer application are preferably sent to the processing center 180. Once a short message dispatch is requested by the retailer application, the short message 223 is delivered to the Short Message Service Center (SMSC) 80, which stores message 223 and forwards it to the processing center 180. In other embodiments, short message 223 could be transmitted to devices other than processing center 180. Also, SMSC 80 is optional, and may be any network component that communicates to the processing center 180.

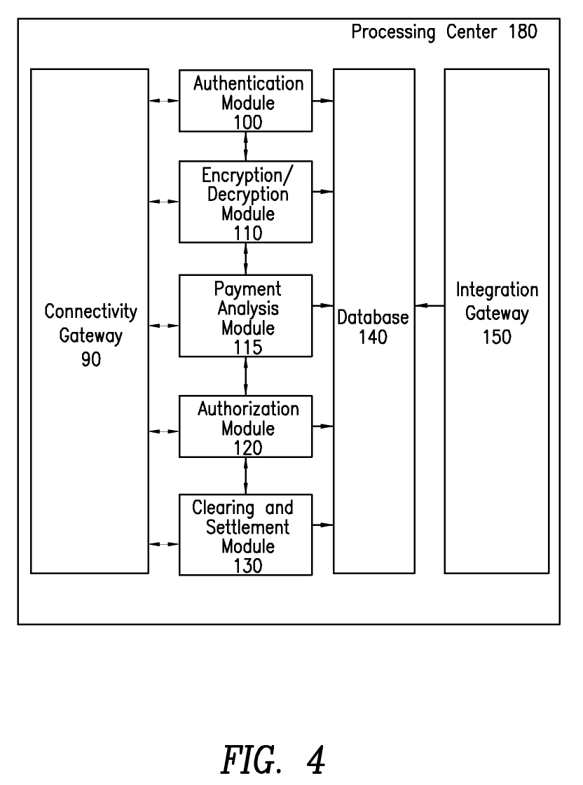

FIG. 4 is a functional block diagram illustrating the preferred structure of the processing center 180, which may include: the connectivity gateway 90, the authentication module 100, the encryption/decryption module 110, the authorization module 120, the clearing and settlement module 130, the processing center database 140, and the integration gateway 150. FIG. 4 also shows a payment analysis module 115 that may be used, for example, to suggest accounts from which payment may be made as previously described. It will be appreciated that in other embodiments, processing center 180 could include fewer or more components than those shown in FIG. 4.

Connectivity gateway 90 may serve as a gateway between any mobile network and the processing center 180. The connectivity gateway 90 is responsible, for example, for encoding and decoding short messages that are exchanged between the processing center 180 and a mobile network Short Message Service Center (SMSC), or other mobile network. The encoding process represents the transformation of application messages 222 into short messages 223; and the decoding process represents the transformation of short messages 223 into application messages 222. The encoding and decoding steps are preferably performed because the Short Message Service Center (SMSC) preferably processes short messages and the processing center 180 preferably processes application messages in order to conduct an electronic transaction, such as an electronic commercial transaction.

With reference to the embodiment of FIGS. 1 and 4, the connectivity gateway 90 is integrated with the wireless network through link 85. This link 85 can be a Transmission Control Protocol/Internet Protocol (TCP/IP), X.25 or equivalent. The link 85 carries short messages 223 using a communication protocol, such as the Short Message Peer-to-Peer Protocol (SMPP) or equivalent. The Short Message Peer-to-Peer Protocol (SMPP) protocol is an open, industry standard protocol designed to provide a flexible data communications interface between Short Message Centers, such as a Short Message Service Center (SMSC), standard Global System for Mobile Communications (GSM) Unstructured Supplementary Services Data (USSD) Server or other type of Short Message Centers and an application solution, in this case, the processing center 180. The link 85 security can be fortified using a Virtual Private Network (VPN). The use of a Virtual Private Network (VPN) increases the level of security by encrypting all the information exchanged between the parties. Depending upon the type of encryption algorithm applied the integrity and the confidentiality of each transaction between them can be increased. Several solutions can be applied for establishing a secure Virtual Private Network (VPN).

Turning to the other components of processing center 180, the authentication module 100 verifies whether the application message received from the connectivity gateway 90 has as a source a trusted third party registered in the processing center database 140. The authentication module 100 uses the mobile device identity specified in the short message to validate the source of the application message in the processing center database 140. In addition to this, the authentication module 100 also has the responsibility of checking the payer 10 personal password against the processing center database 140 for purchase confirmation operations. Other authentication methods can be applied in addition to use of the mobile phone number.

The encryption/decryption module 110 is in charge of guaranteeing the data confidentiality of the application messages by encrypting or decrypting the data. It uses a cryptographic algorithm based on symmetric keys and seed exchanges. However, other cryptographic schemes can be used, according to the security requirements. The same algorithm may be implemented as part of the software applications residing on the Subscriber Identity Module (SIM) card 30, in order to decrypt the application messages received from the processing center 180 and encrypt the application messages that will be sent to processing center 180.

The payment analysis module 115 includes intelligence to ascertain the most efficient manner in which the financial transaction should occur, including which of plural accounts to debit, etc. This decision making process can be accomplished by a set of fixed parameters, parameters that may be updated and/or selected by a user, dynamic parameters from other sources, such as interest rates, etc., or any combination of these and others.

The authorization module 120 may approve or decline individual electronic commercial transactions according to pre-configured parameters. The approval process is based on business rules that are specified, for example, by partner companies, indicating whether the payer 10 account funds are available and whether the electronic transaction can be completed. During the authorization process, the payer or the payee account status and the authorization limits, among other specified parameters, are checked.

The clearing and settlement module 130 is responsible for transferring money from the account of payer 10 to an appropriate payee account. The transfer of financial value can be performed at the time of the transaction or some time thereafter, according to the defined business rules set in the processing center 180. It is also possible to define whether the processing center 180 will charge additional fees such as processing fees or taxes in connection with the transaction.

The processing database 140 preferably contains all the business rules that apply to all accounts and to all participants (i.e. payers and/or payees) in electronic transactions conducted by processing center 180. In this context, such participants may be individual persons, stores, Internet commerce sites or other business entities as discussed elsewhere herein. Each application message in the processing center 180 preferably has a unique number that allows its identification in the processing center 180. When the authorization module 120 approves an electronic transaction, a new unique number, referred to herein as an authorization number, is assigned to the electronic transaction. These authorization numbers uniquely identify the electronic transaction in the processing center 180 and are used for auditing purposes and electronic transaction retrieval. Processing center 180 preferably provides a receipt for every successful electronic transaction wherein each receipt contains the authorization number for the corresponding transaction. The receipt for each transaction is preferably provided to a payer and payee as an acknowledgment of a successfully completed electronic transaction.

With reference to FIGS. 1 and 4, the integration gateway 150 is operable to interact with the external partners, such as the credit card companies 170, financial institutions 160, other processors 190 or loyalty programs 200, which are referred to herein as external partners. Integration gateway 150 acts as an interface between the processing center 180 and the external partners, which allows the external partners 160, 170, 190, 200 to set specific parameters for each payee or payer. Parameters that can be set by the external partners may include, but are not limited to: authorization limits, applicable taxes, interest charges, and other applicable parameters. A financial institution is responsible for funding a commercial transaction, which may include a cashless operation. The initial amount of money in a payer account may be provided by a financial institution, such as a bank. The money provided can later be retrieved by deposits in the financial institution account. In some embodiments, the initial amount of money, or initial credit amount, that is provided to an account associated with a user (such as a payer or payee), to a mobile device, and/or to an account associated with the user or mobile device, may be determined based on a) an average call volume and/or b) an average bill amount for that user's mobile device. Upon determining the amount as described above, a financial institution may then proceed to credit the account.

The communication between the integration gateway 150 and the external partners 160, 170, 190, 200 may be carried out according to the ISO 8583 Protocol, the Standard for Financial Transaction Card Originated Messages. This specification is in accord with the International Organization for Standardization for systems that conduct electronic transactions. However, the invention is not limited to the use of the above-described communication protocol.

An electronic, cashless payment may be conducted through a sequence of operations by a payer or between the involved parties. These operations may be conducted between the parties by means of the mobile device communication module as short messages. The short messages are dispatched to a Short Message Service Center (SMSC) 80, which is responsible for forwarding the messages to the respective targeted entities.

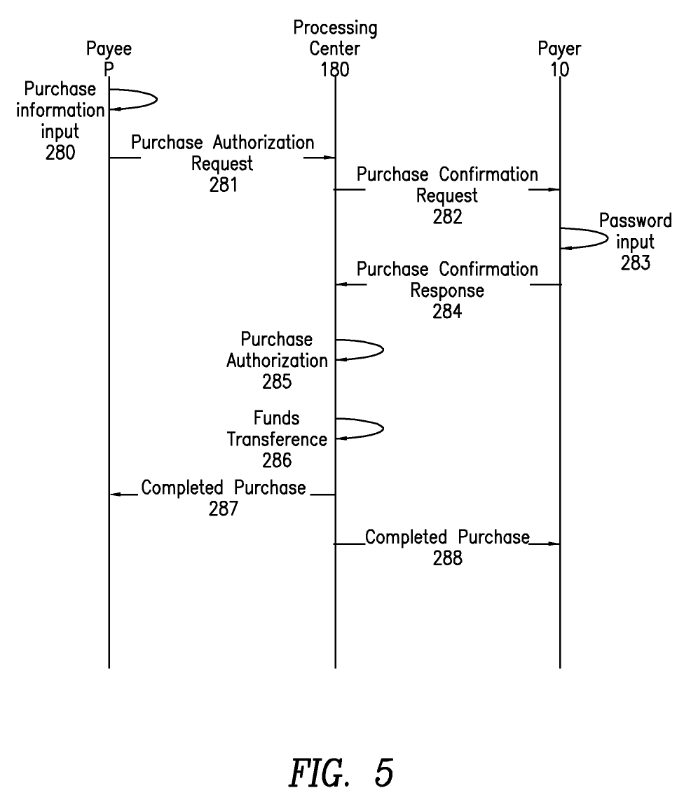

A typical two party transaction is illustrated in the flow diagram of FIG. 5. A payee P initiates a purchase transaction. A purchase authorization request containing the purchase data is formatted and is sent (281) to the processing center 180. The processing center 180 validates the payee identity and sends (282) a purchase confirmation request to the payer 10. The payer 10 confirms the purchase information and inputs (283) his personal password into his mobile device 20. A purchase confirmation response containing the payer personal password is formatted and is sent (284) to the processing center 180. The processing center 180 authenticates payer identity, verifies his personal password and authorizes (285) the purchase based on the parameters set in the authorization module. Following the authorization, the processing center 180 conducts the funds transfer 286 and sends (287) a successful purchase confirmation to payee P and to payer 10. If any of the above-discussed steps are not successfully completed, the purchase authorization process fails, and the purchase transaction is preferably not completed. In this case, both the payer 10 and the payee P receive an error message.

In a preferred embodiment, prior to the payment or other financial transaction being facilitated, the system would transmit one or more selections to the user in order to permit the user to approve of the source of the funds for the transaction. Preferably, the selections will also be displayed with a system recommendation so the user can accept the system's selection of the preferred source, or can override system selections. The payment analysis module 115 of FIG. 4 may select such sources based upon any of a variety of business rules, such as minimizing interest, maintaining each of plural accounts with sufficient funds in them, etc.

Processing center 180 includes a payment processor, preferably in the clearing and settlement module 130. A user, such as a payer would set up an account in the payment processor upon registering with the system. During the registration process, he would identify various types of credit that he has, such as credit cards and payment accounts and also various payments that may be due in the future. This information would be updated on a regular basis. The user then specifies which credit account would be used to make each type of payment. Preferably, the payment processor has access to a payment analysis module 115 which, based upon the balances in each account, interest rates paid, etc, can suggest to the payer what account to use for a particular payment.

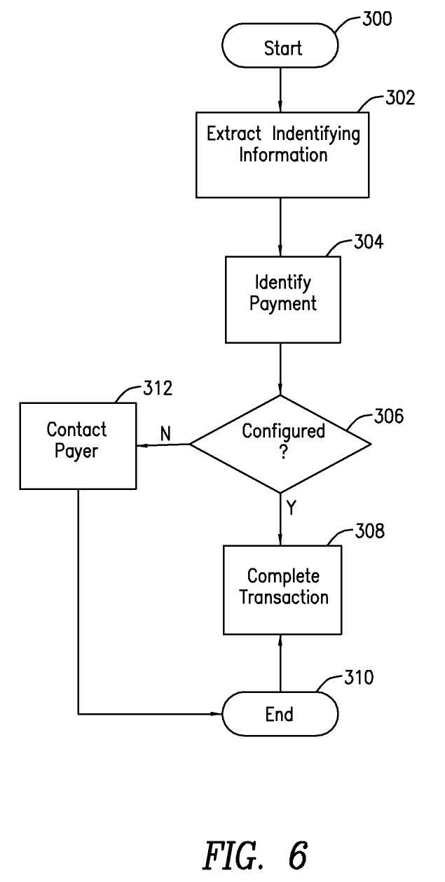

FIG. 6 is a flow chart illustrating the overall process performed by the payment processor. The process starts at block 300, and identifying information of the payer is extracted at block 302. This can include the telephone number from which the payment instructions are received or any other identifying information selected by the user. At block 304, the particular payment is identified and, at block 306 a test is performed to determine whether the user has configured the payment processor to handle this particular payment. If so, the transaction is completed at block 308. This would typically include notifying the payer that the payment has been completed. If, however, the payment could not be completed for some reason he could be notified of that fact. The process ends at block 310.

Should it be determined that block 306 that the payment processor has not been configured to make this particular payment, the payer is contacted at block 312. This block will typically carry on an interactive process with the payer, during which he effectively configures the payment processor with respect to the particular payment involved. Upon the completion of the process in block 312, control transfers to block 308, where the transaction is completed.

It is also noted that the authorization and settlement module may include software that selects from where the payment should be made, with or without help from a payer. For example, the database may show that the user has three accounts, but that one of the three accounts yields a much lower interest rate. Hence, depleting this account to pay a bill is more efficient than depleting another account. On the other hand, the authorization module may advise the payer, via his mobile device, which accounts have sufficient funds, and permit the user to either make a selection, override a default selection, or accept or reject a recommended payment source.

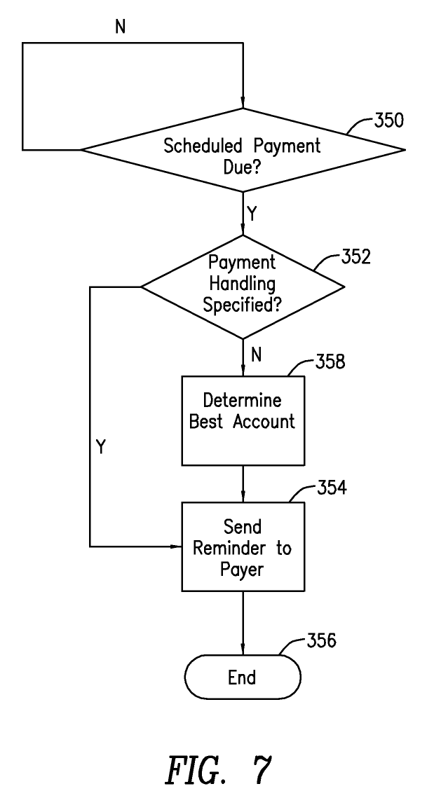

It is contemplated that the payment processor will permit a payer to schedule payments and create reminders. FIG. 7 is a flow chart illustrating the process performed by the payment processor to generate payment reminders. At block 350, a test is performed to determine whether a payment is due. The process proceeds no further unless a payment is due, at which point control transfers to block 352. At block 352 a test is performed to determine whether payment handling has been specified. If so, control transfers to block 354 where a reminder is sent to the payer, preferably to his mobile device. The process ends at block 356. If it is determined at block 352 that payment handling has not been specified for this payment, the payment analysis module determines at block 354 which account would best be used to make the payment. Control then transfers to block 354 where a reminder is sent to the payer, in this case with a recommendation as to which account is to be used to make the payment.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims. Most of the methods described herein need not be limited to mobile devices, and the transactions need not be limited to payment of a fee, but can be any commercial ecommerce transactions.

1. A system, comprising:
a payment processor having access to stored information representing payment accounts from which payments may be made on behalf of a payer and information specifying how a payment due is to be paid from one or more of the accounts, comprising:
a first processing module identifying the payer and an actual payment due based upon received information;
a second processing module determining the account from which the actual payment due is to be paid based on the stored information; and
a mobile device operable by the payer and constructed to communicate with the payment processor so as to provide information thereto about the actual payment due, and sources from which said payment may be made.

2. The system of claim 1 wherein the mobile device is remote from the payment processor.

3. The system of claim 1 wherein the mobile device communicates with the payment processor wirelessly, and wherein the processor facilitates the movement of at least some financial value from an account associated with the payer.

4. The system of claim 1 wherein the mobile device is selected from the group consisting of: a cell phone; a notebook computer; and a Personal Digital Assistant (PDA).

5. The system of claim 1 wherein the plurality of devices are in communication with the payment processor.

6. The system of claim 5 wherein each said devices is operated by one of the group consisting of: a person, a business; a business cash register; an automatic teller machine (ATM); and an Internet commerce site.

7. The system of claim 1 wherein a subscriber identification module (SIM) card is disposed in communication with said mobile device.

8. The system of claim 7 wherein the SIM card is incorporated within the mobile device.

9. The system of claim 1 wherein the payment processor further comprises a payment analysis module responsive to stored and received information to determine which account should best be used to make an actual payment due.

10. The system of claim 1 wherein the payment processor further comprises a payment scheduler effectuating the generation a reminder sent to the mobile device regarding an actual payment due.

11. A method, comprising:
providing a payment processor including a first processing module identifying the payer and an actual payment due based upon received information and a second processing module determining the account from which the actual payment due is to be paid based on the stored information;
communicating with the payment processor via a mobile device to provide information about an actual payment due by a payer;
employing the payment processor to effectuate payment of the actual payment due in from a source specified or derived from prestored information, unless an authorized payer overrides said prestored information.

12. The method of claim 11 further comprising storing a reminder about the actual payment due and providing a reminder message to the mobile device when the payment is due.

13. The method of claim 11 wherein the payment processor further comprises a payment analysis module responsive to stored and received information to determine which account should best be used to make an actual payment due, the payment analysis module determining a recommended account for payment of the actual payment due and communicating the recommendation to the mobile device.

14. A method comprising maintaining a database of users, and for each user, associated accounts and financial transactions to take place, transmitting to a wireless device information regarding a financial transaction and a recommended source of funds for such transaction, and, in response to a user designating said source, transmitting such designation to a server, and facilitating said financial transaction at the server.

15. The method of claim 14 wherein said financial transaction is facilitated by moving value from one mobile device to another.
